(19) United States
(12) Patent Application Publication
(10) Pub. No.: US 2010/0082846 A1
(43) Pub. Date: Apr. 1, 2010

(54) USB DEVICE AND METHOD FOR CONNECTING THE USB DEVICE WITH USB HOST

(76) Inventors: Kyung Hwan KIM, Anyang-si (KR); Won Bin Jang, Anyang-si (KR); Jung Su Lee, Anyang-si (KR); Ju Ho Ha, Anyang-si (KR); Uee Song Lee, Anyang-si (KR); Jong Pil Won, Anyang-si (KR)

Correspondence Address: BIRCH STEWART KOLASCH & BIRCH, PO BOX 747, FALLS CHURCH, VA, 22040-0747, US

(21) Appl. No.: 12/570,530

(22) Filed: Sep. 30, 2009

Related U.S. Application Data
(60) Provisional application No. 61/101,997, filed on Oct. 1, 2008.

(30) Foreign Application Priority Data
Dec. 26, 2008 (KR) 10-2008-0134478

(51) Int. Cl. G06F 13/38; G06F 3/00

(52) U.S. Cl. 710/14; 710/63; 710/60

(57) ABSTRACT

A method for connecting a universal serial bus (USB) device to a USB host is disclosed. The method for connecting the USB device to a USB host includes detecting a connection to the USB host; controlling the USB host not to recognize the connection of the USB device; selecting one of USB modes provided by the USB device; and controlling the connection so as to allow the USB host to recognize the selected USB mode.

This application claims the benefit of Provisional Application No. 61/101,997, filed on Oct. 1, 2008, which is hereby incorporated by reference as if fully set forth herein. This application claims the benefit of Korean Patent Application No. 10-2008-0134478, filed on Dec. 26, 2008, which is hereby incorporated by reference as if fully set forth herein.

### BACKGROUND OF THE INVENTION

1. Field of the Invention

The present invention relates to a universal serial bus (USB) device and a method for connecting the USB device to a USB host.

2. Discussion of the Related Art

In recent times, a universal serial bus (USB) module has been widely used as a communication part between electronic devices. In the present invention, for convenience of description and better understanding of the present invention, two devices interconnected by the USB module are referred to as a USB device and a USB host, respectively. For example, a mobile terminal (for example, a mobile phone, a personal digital assistant (PDA), or a smart phone) and a USB memory used as a storage medium may be used as the USB device. In addition, a device (e.g., a personal computer (PC)) capable of using the USB device as a peripheral device may be used as the USB host. However, although the USB device and the USB host are differently referred to according to their functions, a particular device is not limited to only the USB device or the USB host and is also applicable to other examples as necessary.

### SUMMARY OF THE INVENTION

Accordingly, the present invention is directed to a universal serial bus (USB) device and a method for connecting the USB device to a USB host that substantially obviates one or more problems due to limitations and disadvantages of the related art.

An object of the present invention is to provide a USB device and a method for effectively connecting the USB device to the USB host.

Technical subject matters to be realized by embodiments of the present invention are not limited to only the following technical subject matters, and other technical subject matters not mentioned in the following description may be easily appreciated by those skilled in the art to which the present invention pertains without difficulty.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for connecting a universal serial bus (USB) device to a USB host includes: detecting a connection to the USB host; controlling the USB host not to recognize the connection of the USB device; selecting one of USB modes provided by the USB device; and controlling the connection so as to allow the USB host to recognize the selected USB mode.

According to an embodiment of the present invention, a universal serial bus (USB) device includes display which provides a display image of selectable USB modes of the USB device; storage which stores a plurality of programs to implement the selectable USB modes; and a controller which detects a connection to an external USB host, controls the USB host not to recognize the connection of the USB device, provides the selectable USB modes of the USB device through the display so as to enable a user to select one of the selectable USB modes as a selected USB mode, and controls the connection so as to allow the USB host to recognize selected one of the selectable USB modes.

According to an embodiment of the present invention, a method for connecting a universal serial bus (USB) device to a USB host includes controlling a pull-up resistor of the USB device to be disabled; detecting a connection to the USB host selecting one of USB modes provided by the USB device; and controlling the connection so as to allow the USB host to recognize the selected USB mode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a universal serial bus (USB) device and a USB host according to an embodiment of the present invention.

FIGS. 2A and 2B illustrate a USB cable and a USB connector applicable to a USB module, respectively, and FIG. 2C illustrates different colors and functions of pins of a USB cable.

FIG. 3 is a flow chart illustrating a method for connecting a USB device to a USB host according to an embodiment of the present invention.

FIG. 4 illustrates a connection status between a USB device and a USB host according to an embodiment of the present invention.

FIG. 5 illustrates an example for selecting a USB function according to an embodiment of the present invention.

FIGS. 6 and 7 illustrate connection statuses between a USB device and a USB host according to selected USB functions according to embodiments of the present invention.

FIG. 8 is a flow chart illustrating a method for operating a USB device and a USB host according to an embodiment of the present invention.

FIG. 9 is a block diagram illustrating constituent components of a USB device according to an embodiment of the present invention.

FIG. 10 is a flow chart illustrating a method for connecting a USB device to a USB host according to another embodiment of the present invention.

### DETAILED DESCRIPTION OF THE INVENTION

Reference will now be made in detail to embodiments of the present invention, examples of which are illustrated in the accompanying drawings. Wherever possible, the same reference numbers will be used throughout the drawings to refer to the same or like parts. Constituent components and operations of the present invention shown in the drawings will be disclosed for only illustrative purposes of the present invention, such that technical spirit, important constructions and operations of the present invention are not limited to only the following embodiments, and can also be applied to other embodiments.

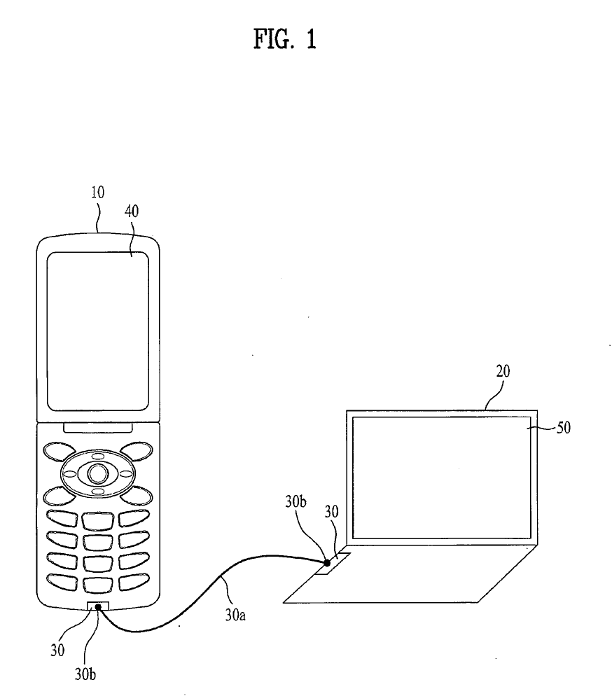

FIG. 1 illustrates a universal serial bus (USB) device and a USB host according to an embodiment of the present invention. As shown in FIG. 1, a USB device 10 includes not only a USB module 30 including hardware for USB connection but also a display unit 40. The USB host 20 includes not only a USB module 30 including hardware for USB connection but also a display unit 50. The USB module 30 of the USB device 10 is physically connected to the USB module 30 of the USB host 20 via a USB cable 30a.

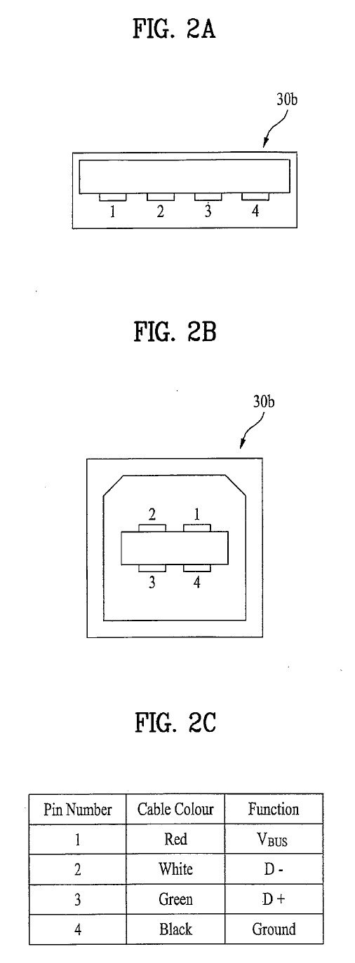

FIGS. 2A and 2B illustrate a portion of the USB cable 30a and a USB connector 30b applicable to the USB module 30 of the USB device 10 and the USB host 20, respectively. As shown in FIGS. 2A and 2B, the USB connector 30b includes at least four pins (PIN1, PIN2, PIN3, and PIN4). Pin numbers “1” and “4” are associated with a power source (Vbus, Ground). In other words, it can be easily recognized that the USB host is connected to the USB device by referring to output signals of the pin numbers “1” and “4”. A pin number “3” is referred to as a D+ terminal, a pin number “2” is referred to as a D− terminal, and each of the pin numbers “3” and “2” is associated with a USB pull-up resistor. Specifically, the USB pull-up resistors connected to the D+ and D− terminals are associated with a transfer rate between a USB device and a USB host, and a detailed description thereof will be described below.

In addition, respective pins 1-4 of a USB cable 30a may have different cable colors. For example, as shown in FIG. 2C, respective pins 1-4 of the USB cable 30a may be colored in red, white, green, and black, respectively, so that they can be easily distinguished from each other. However, the particular colors or their correspondence to respective pins are not limited.

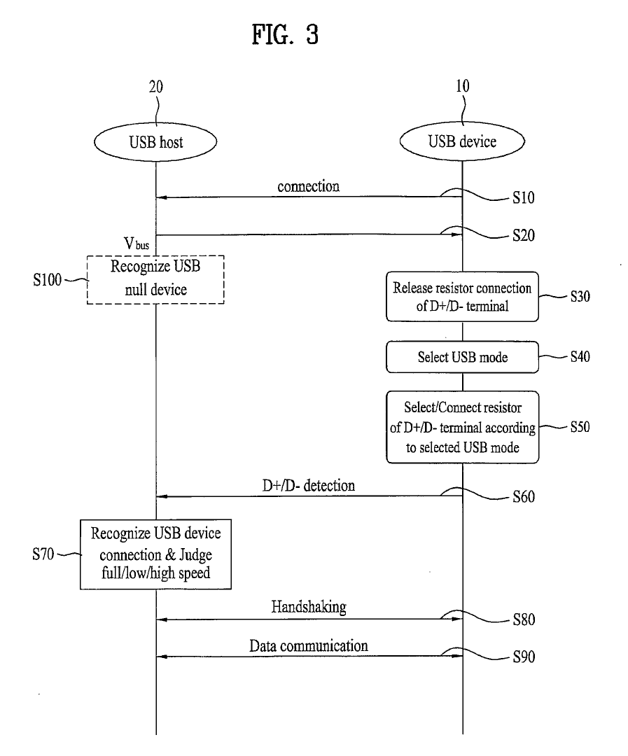

FIG. 3 is a flow chart illustrating a method for connecting a USB device to a USB host according to an embodiment of the present invention. As shown in FIG. 3, when a USB device is physically connected to a USB host at step S10, the USB host provides the USB device with a power-supply voltage (Vbus) at step S20. Through the step S20, it can be recognized that the USB device is physically connected to the USB host.

After performing the above step S20, the USB device is disconnected from pull-up resistors connected to the D+/D− terminals at step S30, so that the USB host is unable to recognize the pull-up resistors. In other words, the meaning of this step S30 indicates a specific status in which the USB host cannot recognize a connection of the USB device at step S100. This specific status will be referred to as a “USB null device” status in embodiments of the present invention. That is, the USB host decides (recognizes, registers or notes) that a status is a disconnection status of the USB device until resistors connected to the D+ and/or D− terminal(s) are detected through pins “2” and “3” of the USB connector 30b. That is, in the USB null device status, the USB host 20 does not recognize, registers, or notices that the USB device 10 is connected to the USB host 20 via the USB cable 30a.

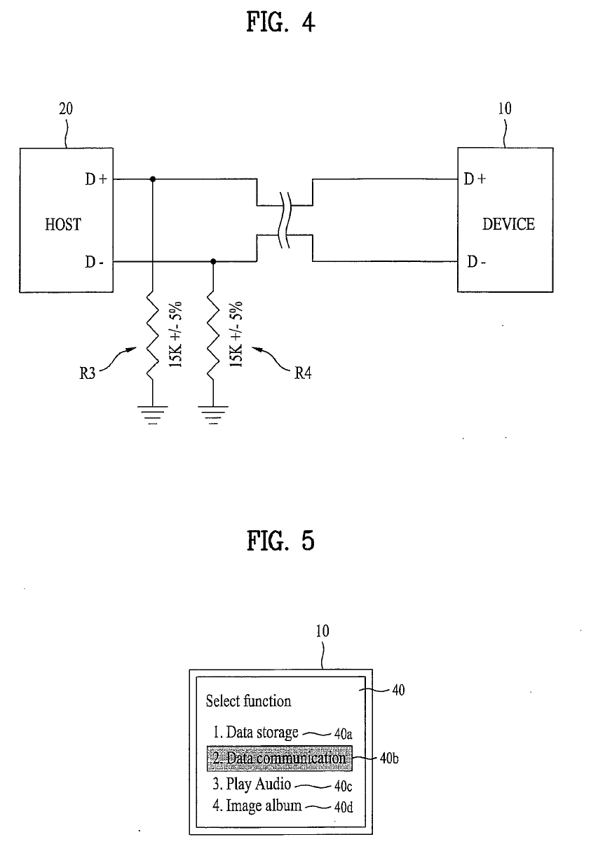

In association with the above description, FIG. 4 is a conceptual diagram illustrating that a connection status of the USB device is recognized as a USB null device status. In other words, the USB device 10 temporarily opens (disconnects or disables) resistors connected to the D+/D− terminals so that the USB device 10 may control the USB host 20 not to recognize a connection of the USB device 10. For better understanding of the present invention, resistors R3 and R4 connected to the D+/D− terminals of the USB host 20 are used to detect resistors connected to the D+/D− terminals of the USB device 10, and are generally designed to have impedance of about 15K (±5%).

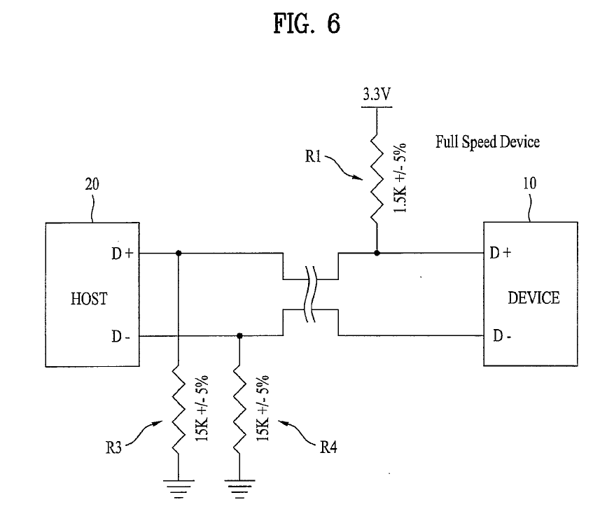

The USB device selects an available USB mode while the USB host recognizes the USB device as a USB null device (i.e. while the USB host does not recognize connection of the USB device to the USB host) at step S40. The USB mode may be established in various ways according to a USB device design. FIG. 5 illustrates a variety of USB modes (or functions), for example, a data storage mode 40a, a data communication mode 40b, a play audio mode 40c, an image album mode 40d, and the like. In association with the above description, the USB mode may be selected by a user or may also be automatically selected by a system. In order to allow the user to select a desired USB mode, as shown in FIG. 5, USB modes selectable by (or using) a display unit 40 contained in the USB device 10 may be provided to the user. Accordingly, the user is able to select any one of USB modes provided through the display unit 40.

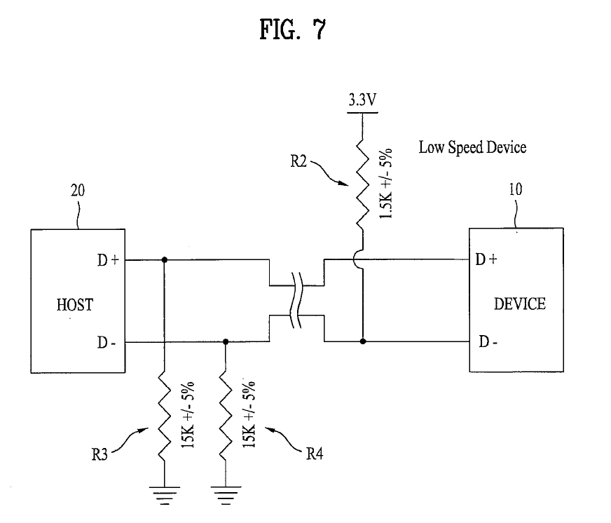

After performing the step S40, i.e., after a USB mode is selected by a user or a system, the USB device connects a resistor appropriate for the selected USB mode to the D+ or D− terminal at step S50. In more detail, when the USB device is to be operated at a full speed based on a selected USB mode, a pull-up resistor is connected to the D+ terminal, such that the USB host is able to determine a transfer rate of the USB device to be the full speed. FIG. 6 shows a pull-up resistor R1 that is connected to a D+ terminal when the USB device is operated as a full speed device. It is preferable that the resistor R1 be designed to have the same impedance as that of another resistor R3 connected to the D+ terminal of the USB host.

The USB device may be operated at a full speed in various cases. For example, in a case where the USB mode is a data communication mode 40b of FIG. 5 and the USB device is used as a USB modem, the USB device would be operated at the full speed.

When the USB device is to be operated at a low speed based on a selected USB mode, a pull-up resistor is connected to the D− terminal so that the USB host is able to determine a transfer rate of the USB device to be a low speed. FIG. 7 illustrates that a pull-up resistor R2 is connected to the D− terminal when the USB device is to be operated as a low speed device. It is preferable, but not required, that the resistor R2 be designed to have the same impedance as that of another resistor R4 connected to the D− terminal of the USB host.

The USB device may be operated at a low speed in various cases. For example, in a case where the USB mode is a USB CD-ROM mode, such as when the USB device is used as a USB CD-ROM, the USB device can be operated at the low speed.

Generally, if the USB device is operated at a high speed, a pull-up resistor is connected to the D+ terminal, and a USB host recognizes the pull-up resistor and transmits/receives chirp-j/k signals within a predetermined time, so that the USB host confirms a high speed device through the chirp-j/k signals. This method for judging the high speed device using the chirp-j/k signals is well known in the art to which the present invention pertains, according to a USB standard, so that a detailed description thereof will be omitted herein for convenience of description and better understanding of the present invention.

If resistors (pull-up resistors) are connected to the D+/D− terminals at step S50, a USB host detects the resistors connected to the D+/D− terminals at step S60, and detects a transfer rate of a USB device connected to the USB host based on the connected state of the a resistor(s) to the D+/D− terminals at step S70. After performing the step S70, the USB host and the USB device confirm whether they communicate with each other or are in communication through a handshaking process at step S80. After performing the successful handshaking process, data communication between the USB host and the USB device is carried out at step S90.

As described above, the method for connecting the USB device to the USB host according to the present invention have the following characteristics. In other words, according to a general USB device of the related art, decision about whether connected USB devices are full/low/high speed devices is carried out according to a predefined hardware scheme (i.e., the scheme for connecting resistors to the D+/D− terminals) that are fix. This decision operation or scheme has a disadvantage in that it may not consider or allow interaction with a user by way of selecting a USB function. On the contrary, according to embodiments of the present invention, a USB host first recognizes (or is made to recognize) a USB device as a null device, which allows a user (or a system) to select a desired USB function (that is implemented with a USB mode) during the above null device recognizing time, resulting in an increase in a USB device mode availability for the user. That is, instead being dependent on a predetermined speed configuration of a USB device, a user is able to select a speed or a USB mode that is optimal or better for a desired use of the USB device by the user.

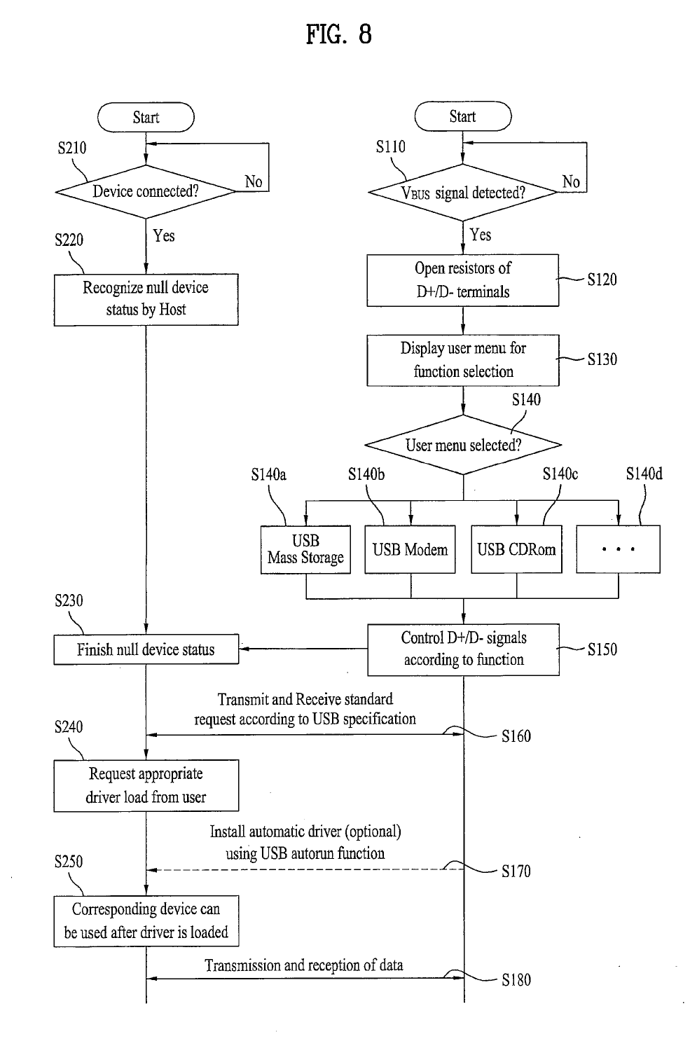

FIG. 8 is a flow chart illustrating a method for operating a USB device and a USB host according to an embodiment of the present invention. In FIG. 8, steps S110 to S150 illustrate operations of the USB device, and other steps S210 to S250 illustrate operations of the USB host. In addition, steps S160 and 180 illustrate mutual operations between the USB device and the USB host.

Operations of the USB device will hereinafter be described with reference to FIG. 8. The USB device is connected to the USB host, and it is determined whether the USB device detects a power-supply voltage (Vbus) received from the USB host at step S110. If the power-supply voltage (Vbus) is detected by the USB device at step S110, resistors connected to the D+/D− terminals are opened (disconnected or disabled) at step S120, as shown in FIG. 4, such that the USB host does not recognize a connection of the USB device. Thereafter, the USB device provides a user with a USB function (or USB mode) selectable by way of a display unit (for example, a reference number 40 of FIG. 1) at step S130. FIG. 5 illustrates an example of a display image given to the user.

Then, the user selects a USB mode of the USB device through the display image at step S140. For example, the user may be able to select any one of the following modes S140a, S140b, S140c and S140d. In more detail, the first mode S140a represents that a USB is used as a mass storage medium at step S140a, the second mode S140b represents that a USB is used as a communication modem, the third mode S140c represents that a USB is used as a CD-ROM, and the fourth mode S140d represents that a USB is used for other various USB functions.

If one of the above USB modes S140a˜S140d is selected at step S140, the USB device controls resistors of the D+/D− terminals according to the selected USB mode at step S150. For example, in case of a USB mode requiring the full speed as shown in FIG. 6, the USB device is connected to a resistor R1 of the D+ terminal, or connects the resistor R1 to the D+ terminal. In case of a USB mode requiring the low speed as shown in FIG. 7, the USB device is connected to a resistor R2 of the D− terminal, or connects a resistor R2 to the D− terminal. In case of a USB mode requiring the high speed, the USB device is connected to the resistor R1 of the D+ terminal, or connects the resistor R1 to the D+ terminal, and recognizes the high speed through subsequent chirp-j/k signals.

According to the result of the above step S150, the USB host then terminates a USB null device status at step S230, and recognizes a connection of a specific USB device, a corresponding speed and/or a corresponding USB mode. After the above step S230 is performed, a request based on the USB standard specification is communicated between the USB host and the USB device, and a handshaking process is also carried out between the USB host and the USB device at step S160.

In association with the above-mentioned description, in order to control the USB host to communicate with the USB device according to the selected USB mode and/or a corresponding speed, an execution program (that is generally called a driver) for the selected USB mode is required. Accordingly, if the corresponding driver is not present in the USB host, the USB host requests a user to install the corresponding driver at step S240. For convenience of description and better understanding of the present invention, the installation of the above driver is referred to as a ‘load’.

In association with the request for loading the above specific driver, the user may directly carry out the driver load in the USB host using a corresponding program. However, for convenience of description and better understanding of the present invention, the present invention will disclose another case S170 in which a USB device transmits a driver for the selected USB mode to the USB host.

In other words, at step S170, the USB device may automatically load the driver for executing the selected USB mode in the USB host using an autorun file provided in the USB host. In more detail, not only a command for loading a corresponding program in the USB host but also a program for supporting a corresponding USB mode are simultaneously provided and transmitted in the autorun file, so that the user need not install an additional driver in the USB host, resulting in greater convenience of the user.

After performing the above step S170, if the driver for executing the corresponding USB mode is completely installed in the USB host, data communication between the USB host and the USB device can be carried out at steps S250 and S180.

Next, operations of the USB host will hereinafter be described in detail with reference to FIG. 8. The USB host determines whether it is physically connected to the USB device at step S210. The physical connection between the USB host and the USB device can be confirmed by detecting mutual connection between a power-supply terminal (Vbus) of the USB host and a power-supply terminal (Vbus) of the USB device. The power-supply voltage (Vbus) is transferred to the USB device.

Thereafter, the USB host enters a USB null device, and is in a standby mode until a resistor (or a pull-up resistor) of the D+ or D− terminal in the USB device is completely connected. If the connection of the resistor of the D+ or D− terminal is detected from the USB device (wherein this resistor connection can be detected at step S150), the USB null device status is terminated at step S230. After performing the step S230, the USB host begins to normally communicate with the USB device through a handshaking process, and determines a transfer rate of the connected USB device, for example, based on a connection of the resistor to the D+ or D− terminal of the USB device at step 160. Thereafter, steps S240, S170, S250, and S180 are carried out in the same manner as in the above described USB device operations.

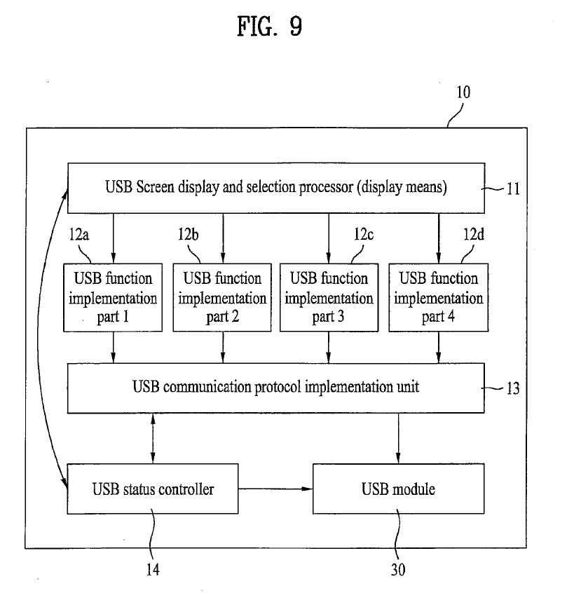

FIG. 9 is a block diagram illustrating constituent components of a USB device according to an embodiment of the present invention. For example, FIG. 9 illustrates only a hardware structure for implementing a connection between the USB device and the USB host. In other words. The USB device 10 may include a USB module 30, a screen display and selection processor 11, USB function implementation units 12a˜12d, a USB communication protocol implementation unit 13, and a USB status controller 14.

The USB module 30 of the USB device 10 includes the above-mentioned USB connector 30b. In addition, the USB module 30 of the USB device 10 includes a hardware structure of respective pins (denoted by pin numbers of FIGS. 2A and 2B) in the USB connector 30b. In other words, for example, the USB module 30 of the USB device 10 may include resistors R1 and R2 connected to the D+/D− terminals that may be released, “pulled up”, or others according to embodiments of the present invention.

The screen display and selection processor 11 serves as a kind of display means (See the reference number 40 of FIG. 1), and carries out a user selection. For example, the display means 40 is implemented with a touch screen, so that the user may select a desired function on the display image, or the user selection may be carried out through an additional user input unit (for example, a keyboard, a remote-controller, and the like).

The USB function implementation units (parts) 12a˜12d indicate execution means for implementing a variety of USB functions supported by the USB device 10. For example, the USB function implementation units 12a˜12d may be implemented with storage means (e.g., a ROM memory, a flash memory, or the like) storing several programs to implement respective USB functions. In other words, a specific USB mode selected by the screen display and selection processor 11 is implemented by executing associated programs stored in the USB function implementation units 12a˜12d.

The USB communication protocol implementation unit 13 provides a communication protocol for allowing a specific USB function selected by the USB function implementation unit to communicate with the USB host through the USB module 30.

Also, the USB status controller 14 controls operations of the USB module 30, the screen display and selection processor 11, the USB function implementation units 12a˜12d, and the USB communication protocol implementation unit 13. In other words, as shown in FIGS. 3 and 8, if the USB device is connected to the USB host, the USB status controller 14 releases the connection of the resistors of the D+/D− terminals contained in the USB module 30, so that it makes (or to obtain) a USB null device status. Subsequently, the USB status controller 14 controls the screen display and selection processor 11, so that a specific USB function can be selected by a user (or be automatically selected by a system). Thereafter, the resistors R1 and R2 contained in the USB module 30 are controlled so that they are connected to the D+ or D− terminal corresponding to the selected USB function. When the resistors R1 and R2 are connected (or the release of the connection ceases) to the D+ or D− terminal, the USB null device status is released, and the USB host can normally communicate with the USB device. The USB status controller 14 controls the USB function implementation units 12a˜12d and the USB communication protocol implementation unit 13, so that data communication between the USB device and the USB host is controlled.

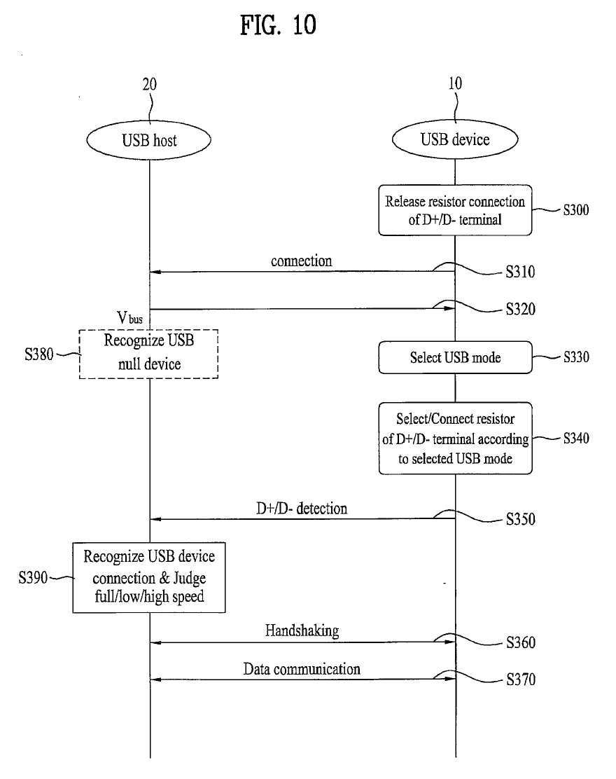

FIG. 10 is a flow chart illustrating a method for connecting a USB device to a USB host according to another embodiment of the present invention. Comparing to the embodiment of FIG. 3, this embodiment of FIG. 10 shows a different process in view of controlling the pull-up resistors before connecting the USB device to the USB host. That is, in advance (or anticipation) of a connection to the USB host, the USB device may be controlled to disconnect the pull-up resistors from the D+/D− terminals at step S300. Afterward, the USB device is physically connected to a USB host at step S310, and the USB host provides the USB device with a power-supply voltage (Vbus) at step S320. Since the pull-up resistors were previously disconnected from the D+/D− terminals at step S300 before the USB device was connected to the USB host at step S310, the USB host is unable to recognize the pull-up resistors so that the USB host cannot recognize a connection of the USB device at step S380 (“USB null device”). Because the following steps S330˜S390 have same function with the steps S40˜S90 of FIG. 3, the detail descriptions of S330˜S390 is omitted.

As described above, the method for connecting the USB device to the USB host according to the present invention have the following characteristics. In other words, according to a general USB device of the related art, decision of full/low/high speed devices may be carried out according to a predefined or fixed hardware scheme (i.e., the scheme for connecting resistors to the D+/D− terminals). This decision operation or schemed has a disadvantage in that it may not consider an interaction with a user by enabling selecting of a USB function. On the contrary, according to embodiments of the present invention, a USB host first recognizes a USB device as a null device, and allows a user (or a system) to select a desired USB function (that is implemented with a USB mode) during the above null device recognizing time, resulting in an increase in a USB device availability to the user.

As apparent from the above description, through the above-mentioned embodiments of the present invention, the USB device can be effectively connected to the USB host since the USB device is able to function in various capacity requiring different connections speeds to the USB host according to various functions.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for connecting a universal serial bus (USB) device to a USB host, the method comprising:
detecting a connection to the USB host;
controlling the USB host not to recognize the connection of the USB device;
selecting one of USB modes provided by the USB device; and
controlling the connection so as to allow the USB host to recognize the selected USB mode.

2. The method according to claim 1, wherein the detecting of the connection is implemented by confirming reception of a power-supply voltage (Vbus) of the USB host.

3. The method according to claim 1, wherein the controlling of the USB host is implemented by disabling a pull-up resistor of the USB device.

4. The method according to claim 1, wherein the selecting of one of the USB modes includes:
providing a plurality of selectable USB modes on a display of the USB device; and
allowing selection of any one of the provided selectable USB modes as the selected USB mode.

5. The method according to claim 1, wherein the controlling of the connection is implemented by a connection of any one of pull-up resistors of the USB device corresponding to the selected USB mode.

6. The method according to claim 1, wherein the controlling of the connection further allows the USB host to recognize the connection of the USB device after the selected USB mode is selected.

7. The method according to claim 1, wherein the USB modes include a data storage mode, a data communication mode, a play audio mode, and an image album mode.

8. The method according to claim 1, wherein each of the USB modes correspond to one of a full speed, a high speed and a low speed of the USB device.

9. A universal serial bus (USB) device, comprising:
display which provides a display image of selectable USB modes of the USB device;
storage which stores a plurality of programs to implement the selectable USB modes; and
a controller which detects a connection to an external USB host, controls the USB host not to recognize the connection of the USB device, provides the selectable USB modes of the USB device through the display so as to enable a user to select one of the selectable USB modes as a selected USB mode, and controls the connection so as to allow the USB host to recognize selected one of the selectable USB modes.

10. The USB device according to claim 9, wherein the controller detects the connection of the USB host to the external USB host by detecting a power-supply voltage (Vbus) of the USB host.

11. The USB device according to claim 9, wherein the controller disables a pull-up resistor of the USB device so as to cause the USB host not to recognize the connection of the USB device to the external USB host.

12. The USB device according to claim 9, wherein the controller controls connection of any one of pull-up resistors of the USB device corresponding to the selected USB mode, so that the USB device completes the connection to the USB host.

13. The USB device according to claim 9, wherein the controller causes the USB host to recognize the connection of the USB device after the selected USB mode is selected.

14. The USB device according to claim 9, wherein the selectable USB modes include a data storage mode, a data communication mode, a play audio mode, and an image album mode.

15. The USB device according to claim 9 wherein each of the selectable USB modes correspond to one of a full speed, a high speed and a low speed of the USB device.

16. A method for connecting a universal serial bus (USB) device to a USB host, the method comprising:
controlling a pull-up resistor of the USB device to be disabled;
detecting a connection to the USB host
selecting one of USB modes provided by the USB device; and
controlling the connection so as to allow the USB host to recognize the selected USB mode.

17. The method according to claim 16, wherein the controlling of the pull-up resistor is implemented by confirming reception of a power-supply voltage (Vbus) of the USB host.

18. The method according to claim 16, wherein the detecting of the connection includes:
providing a plurality of the USB modes on a display of the USB device; and
allowing selection of any one of the plurality of the USB modes.

19. The method according to claim 16, wherein the controlling of the connection is implemented by a connection of any one of pull-up resistors of the USB device corresponding to the selected USB mode.

20. The method according to claim 16, wherein the controlling of the connection further allows the USB host to recognize the connection of the USB device after the selected USB mode is selected.

21. The method according to claim 16, wherein the USB modes include a data storage mode, a data communication mode, a play audio mode, and an image album mode.

22. The method according to claim 16, wherein each of the selectable modes corresponds to one of a full speed, a high speed and a low speed of the USB device.
